(19) United States
(12) Patent Application Publication
(10) Pub. No.: US 2005/0114578 A1
(43) Pub. Date: May 26, 2005

(54) Secure software SMI dispatching using caller address

(76) Inventor: Timothy A. Lewis, Fremont, CA (US)

Correspondence Address: PHOENIX TECHNOLOGIES LTD., 915 MURPHY RANCH ROAD, MILPITAS, CA, 95035, US

(21) Appl. No.: 11/025,194

(22) Filed: Dec. 28, 2004

Related U.S. Application Data
(62) Division of application No. 09/694,288, filed on Oct. 24, 2000.
(60) Provisional application No. 60/161,415, filed on Oct. 25, 1999.

(51) Int. Cl. G06F 13/24

(52) U.S. Cl. 710/260; 710/261

(57) ABSTRACT

A system and method securely transfer control to a system management mode (SMM) in response to an SMI by referencing the address of a calling instruction that generated the SMI with a dispatch table only visible in SMM. The entries in the dispatch table provide links between the calling instruction and its target function. To create the dispatch table, a macro can be inserted in the source code of a software product being built that designates a target function. During compilation, the inserted macro is located, and an entry is created linking the calling instruction and the target function. The calling instruction in the final software product provides no indication of the address of the target function.

### CROSS-REFERENCE

The present application is a non-provision of patent application Ser. No. 60/161,415 filed Oct. 25, 1999.

### FIELD OF THE INVENTION

The present invention relates generally to the operation of a system management mode (SMM) and more particularly to systems and methods for securely transferring control from a normal operation mode into SMM to process a software system management interrupt (SMI).

### BACKGROUND OF THE INVENTION

In 80×86 based systems, there are several normal operating modes including real, protected and virtual modes. During operation in these modes, it is possible for the system to transfer control to a system management mode (SMM). SMM is entered in response to a special interrupt called a system management interrupt (SMI). The generation of an SMI causes the system to enter SMM, which starts to execute code from a different location that can only be seen in SMM. This code executed by the CPU while in SMM is located in system management RAM (SMRAM). When entering SMM, all of the current runtime context and CPU registers are stored in a special area called the CPU save state table, which is accessible to the CPU while in SMM. The save state table is filled either by the system CPU itself, or by code executing immediately upon entry to the SMM.

The CPU or CPUs in a system enter SMM when a pin, typically called SMI#, is asserted. The pin is usually under the control of a single chip in the system, such as the SMI controller, and is asserted in response to various hardware- and software-initiated events. For example, a hardware SMI can be used to profile hardware activity, such as how many times the system accesses its hard drive. Other hardware events may correspond to a timer expiring, temperature measurements, an input signal toggling or a voltage going high on a particular pin. A software SMI can be used, for example, to control power management and to deal with space limitations regarding how much code can be placed in firmware. Typical events for generating a software SMI include writing to an I/O port or writing to a particular memory location. Systems usually provide software to process SMIs and to dispatch, based upon the type of SMI source, to a handling routine.

Within a system it is useful to provide a mechanism for using a single “software” SMI event source to dispatch to multiple possible functions within SMM. Generally, a single SMI event source, along with some means of specifying a target function is used for this purpose. Normally, the target function is specified by loading its execution address into a general-purpose register. Upon detecting the SMI, code for handling the SMI calls the target function by using the value in the general-purpose register. The value of the general-purpose register is read from the CPU save state table, which is the area containing the contents of the CPU registers at the time of the SMI.

When executing in a multi-processor system, it is possible to determine which processor generated the SMI. To make this determination, each CPU's instruction pointer at the time the SMI was asserted, which is found in the CPU save state area, is compared against a table of known execution addresses in the firmware that can generate a software SMI. A match indicates that the CPU generated the SMI. The CPU save state area of the identified processor is then examined for the contents of the general-purpose register that specifies the target function.

It is also possible to validate that the value in the general-purpose register points to an approved target function. A security table adds a list of approved target functions. The contents of the general-purpose register are then compared with all of the entries in the table. If the entry is found, the target function is called. If the entry is not found, then the system exits from SMM. Although this provides the system with some security, it only validates the target function and not the caller, i.e., the code that generated the software SMI.

There are several disadvantages to these SMI handling systems. First of all, since a general-purpose register must be used to hold the target function address, this register cannot be used to pass any other parameters, which results in larger and more difficult code to write. Also, security can be bypassed by calling approved target functions at unapproved times. It is also easy to write “cracking” applications that use a brute-force method of determining approved entry points to the target functions because the calling address is not verified. Another disadvantage is that current implementations which validate the target address do not sort the target table, thus taking more time. Finally, these implementations use a centralized list of approved functions, which often means that more functions than are strictly required for the current product are listed as “approved.”

### SUMMARY OF THE INVENTION

Briefly, consistent with the present invention, in a method for securely transferring control to a system management mode (SMM) after the generation of a system management interrupt (SMI) in a program executing on a computer, the generation of an SMI from a caller in the program is detected. Then, in SMM, it is determined if the caller is included in a dispatch table. Program control is dispatched to a target function that is associated with the caller in the dispatch table if it is determined that the caller is included in the dispatch table. The target function is then executed.

In a further aspect of the present invention, in a method for developing a program system that can validate system management interrupt (SMI) calls generated by a program available in source code form, the source code is compiled. During the compilation, at least one predetermined indication in the source code is identified that identifies the location of an SMI call and its target. A dispatch table is created based on information associated with the predetermined indication, wherein each entry in the dispatch table associates a caller, which generates an SMI in the program, with a target function to be executed in a system management mode (SMM). The dispatch table is stored where it is accessible to a dispatcher in SMM.

### BRIEF DESCRIPTION OF THE DRAWINGS

FIG. 1 is a flow diagram of an SMI handling process.

FIG. 2 is a flow diagram of a process for creating a dispatch table for validating callers of an SMI, consistent with the present invention.

FIG. 3 is a flow diagram of a process for securely transferring control to SMM for a software SMI, consistent with the present invention.

FIG. 4 is a block diagram of a computer for implementing the software SMI handling process, consistent with the present invention.

### DETAILED DESCRIPTION OF THE PREFERRED EMBODIMENTS

The present invention will be described in the context of a specific embodiment, but the invention is not intended to be so limited.

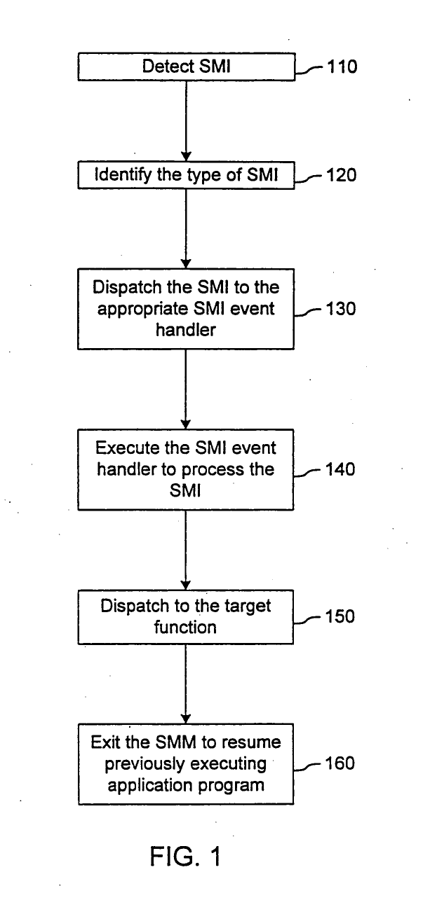

FIG. 1 shows a flow diagram of an SMI handling process. As shown in FIG. 1, the SMI handling process first detects that the currently executing application program has generated an SMI event (step 110). The instruction in the currently executing application program from which the SMI is generated is referred to as the caller. At this point, the current runtime context and CPU registers of the CPU which is executing the application program that generated the SMI are stored in the CPU save state table. The information stored in the CPU save state table is accessible to the SMM if needed when processing the SMI.

The SMI handling process then identifies the type of SMI event (step 120). For example, the SMI may be a software-type or hardware-type SMI, as well as some other type of SMI as is known in the art. Based upon the identified SMI type, the SMM dispatches the SMI to the appropriate SMI event handler (step 130). In general, the SMM includes an SMI event handler for each of the different SMI types that may be generated.

The SMI event handler then begins processing of the generated SMI (step 140). If the SMI is a software-type SMI, the processing of the SMI includes dispatching to a target function associated with the generated SMI (step 150). Generally, the processing of hardware-type SMIs does not include dispatching to a target function. The target function that is dispatched to in processing a software SMI is analogous to a subroutine or function call in an application program. However, the target function that is dispatched to in SMM is only visible within SMM and is inaccessible to the CPU in any other operational mode.

If the system in which the SMI is generated is a multi-processor system, then the SMI event handler also searches through the installed CPUs for a code segment (CS) and instruction pointer (IP) corresponding to one of the installed CPUs in order to determine which CPU save state table is associated with the CPU from which the SMI was generated. It may be necessary to know which CPU's save state table to refer to if the executing target function needs information from the CPU's save state table.

After the execution of the target function has completed, the SMI handling process exits out of SMM and returns control to the previously executing application program (step 160). In addition, the information in the CPU's save state table is restored.

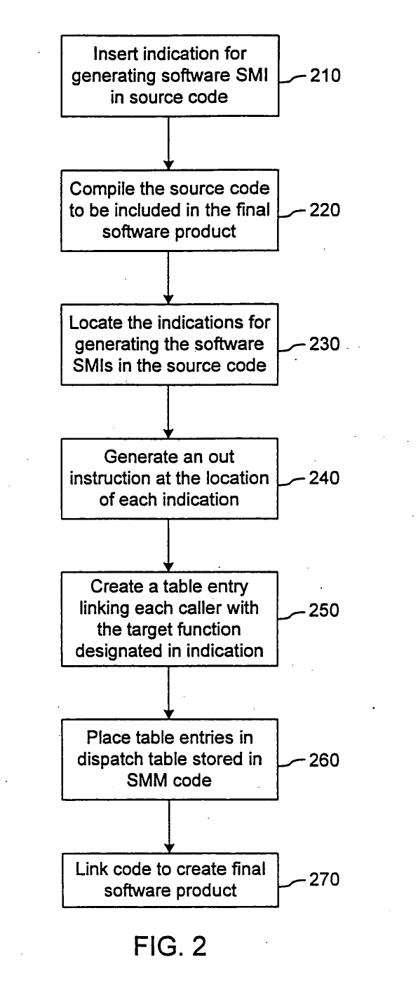

FIG. 2 is a flow diagram of the software program development process for creating a dispatch table for validating the callers of an SMI, consistent with the present invention. To create the dispatch table, which links approved callers with particular target functions, the source code for generating an application program is modified to include an indication that a software SMI is to be generated (step 210). The indication may be implemented, for example, as a macro or as code that explicitly generates the software SMI. A parameter of the indication designates the target function that is to be called in response to the generation of the software SMI. For example, when implemented as a macro, the indication could be macro code that adds the address of the target function which is to be called along with the address of the caller to a special code segment. The point in the source code at which the indication for generating the software SMI appears then corresponds to the “caller” in the discussion presented above.

When this source code is ready to be built into the final software product, such as an application program or a ROM BIOS component, it is first compiled (step 220). During the compilation of the source code, the compiler locates each of the indications for generating the software SMI (step 230). For each of the located indications, the compiler generates an instruction for generating a software SMI at the location of the indication (step 240). Depending upon the particular chipset used in the system, the instruction generated by the compiler may be an “out” instruction. The address of the generated instruction serves as an identification for the caller generating the software SMI. The address of the target function, together with the address of the generated instruction, is placed by the compiler into the special segment along with other similar pairs of caller and target function addresses for other SMI software interrupt calls. However, the generated instruction itself provides no indication of the target function to be executed, or its address, for processing the SMI. By leaving no indication of the identity of the target function in the program code, the link from a caller to a particular target function can only be seen when in SMM, such that someone looking at the code of the final software product would not see the target function being called by an out instruction for generating a software SMI.

In addition to generating an “out” instruction for each located indication, the compiler creates a table entry from the special segment data that links each caller with the corresponding target function designated in the indication (step 250). To identify the caller and its associated target function, each entry is preferably provided with the address of the caller and the address of the target function. Like the generation of software SMIs, the creation of each entry for the dispatch table can be performed using a macro. Each of the created table entries is then placed into the dispatch table by, for example, the compiler, a linker or by a special post-linker, and is stored in the SMM code (step 260). In the last step, the object code created during compilation is linked together to create the final software product (step 270).

When creating the dispatch table from the created table entries, it is possible to optimize the organization of the dispatch table. In particular, a utility may be used to sort the callers by their addresses, as well as to eliminate any duplicate entries. The sorting could also be done during software initialization. By sorting the entries, the processing of software SMIs generated during the execution of the final software product can be speeded up because the SMI event handler can use a binary search instead of a linear search. In addition, by eliminating duplicate entries, the number of entries in the dispatch table is reduced, thereby speeding up the processing of the SMI event handler because it is processing fewer entries. The elimination of duplicate entries also reduces the amount of storage space, such as within a ROM, that is required for the dispatch table.

For further details regarding the compilation, the linking, the use of a segment, and the sorting, please refer to application Ser. No. 09/404,298 to Cohen et al. filed Sep. 24, 1999, entitled “A Software Development System that Presents a Logical View of Project Components, Facilitates Their Selection, and Signals Missing Links Prior to Compilation,” which is incorporated herein by reference.

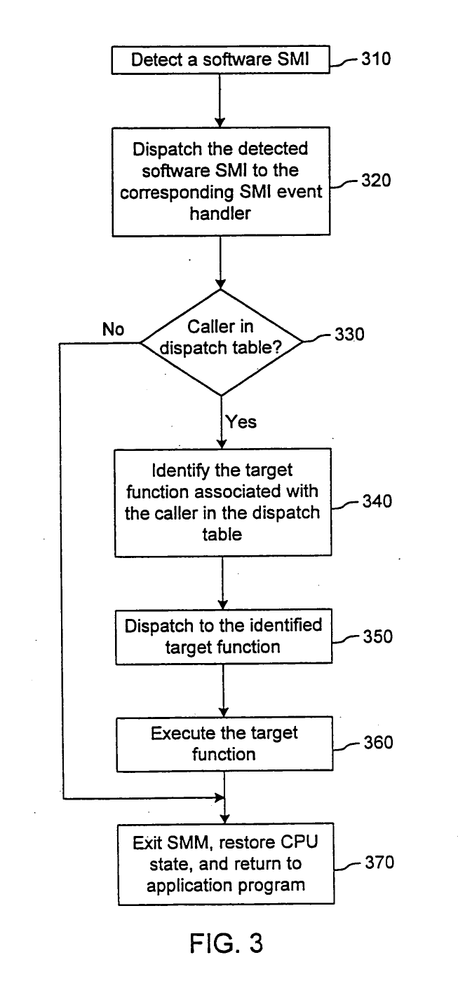

FIG. 3 is a flow diagram of a process for securely transferring control to SMM to process a software SMI, consistent with the present invention. As in FIG. 1, the first step in this process is detect the generation of a software SMI (step 310). The detected software SMI is then dispatched to the SMI event handler that processes software SMIs (step 320). Using the appropriate identification of the caller that generated the detected software SMI, preferably the address of the caller, the SMI event handler searches through the dispatch table to determine if the caller is present in the dispatch table (step 330). If the dispatch table has been sorted, as discussed above, the SMI event handler can perform a binary search to determine if the caller is present in the dispatch table. If the caller is not present in the dispatch table, then the system exits from SMM, restores the information from the CPU save state table, and returns control to the application program at the point where the instruction generated the SMI (step 370).

If the caller is present in the dispatch table, the SMI event handler identifies the target function linked with the caller in the dispatch table (step 340). Like the identification of the caller, the target function is preferably identified by its address. After identifying the target function, the SMI event handler dispatches program control to the target function (step 350). The target function is then executed (step 360). Once the execution of the target function is complete, the system exits from SMM, restores the information from the CPU save state table, and returns control to the application program at the point where the instruction generated the SMI (step 370).

Since the only link between the caller and the target function to be executed is in the dispatch table, and the dispatch table is located in the SMM code, the link from a caller to a particular target function can only be seen when in SMM. As a result, someone looking at the code of the final software product would not see the target function named but would only see an “out” instruction that does nothing but generate a software SMI. Accordingly, only a valid caller, executing from an address that is found within the dispatch table, may generate an SMI that actually dispatches program control to a target function. Since most software SMIs are generated from a ROM code image stored in relatively difficult to access shadow RAM, hacking utilities are much harder to write for this code, thus making the transfer of control to SMM even more secure.

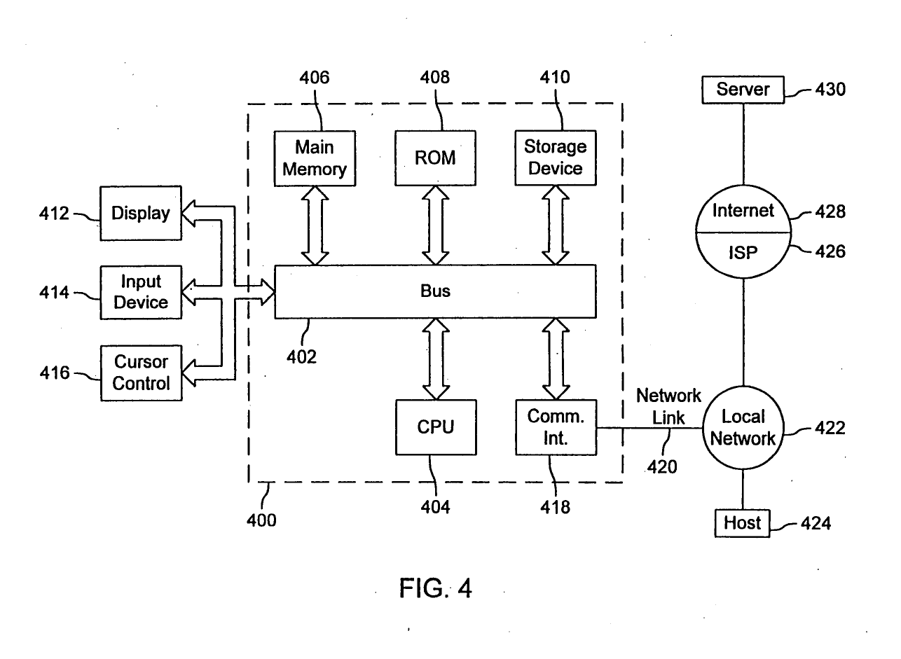

FIG. 4 is a block diagram of a computer system that implements the software SMI handling process of the present invention. As shown in FIG. 4, a computer 400 includes a CPU 404, a main memory 406, a ROM 408, a storage device 410 and a communication interface 418 all coupled together via a bus 402. The CPU 404 may be implemented as a single microprocessor or as multiple processors for a multi-processing system. The main memory 406 is preferably implemented with a RAM and a smaller-sized cache. The ROM 408 is a non-volatile storage device that may be implemented, for example, as an EPROM or NVRAM. The storage device 410 can be a hard disk drive or any other type of non-volatile, writable storage. The programming or code for implementing the software SMI handling process of the present invention is preferably stored in either ROM 408 or storage device 410.

The system includes an SMM RAM 407, which typically is a portion of the main memory RAM 406. SMM RAM 407 is normally not accessible. For example, it may occupy the same address as external video memory. Typically, SMM programs are transferred from the ROM 408 to the SMM RAM 407 during system initialization.

External to computer 400 is a display 412, an input device 414 and a cursor control device 416, which are also coupled to the bus 402. The display 414 may be implemented as a CRT or LCD display device. The input device 414 is preferably a keyboard, and the cursor control device 416 may be implemented as a mouse, a trackball or other pointing device.

The communication interface 418 provides a two-way data communication coupling via a network link 420 to a local network 422. For example, if communication interface 418 is an integrated services digital network (ISDN) card or a modem, communication interface 418 provides a data communication connection to the corresponding type of telephone line. If communication interface 418 is a local area network (LAN) card, communication interface 418 provides a data communication connection to a compatible LAN. Wireless links are also possible. In any such implementation, communication interface 418 sends and receives electrical, electromagnetic or optical signals, which carry digital data streams representing different types of information.

Network link 420 typically provides data communication through one or more networks to other data devices. For example, network link 420 may provide a connection through local network 422 to a host computer 424 or to data equipment operated by an Internet Service Provider (ISP) 426. ISP 426 in turn provides data communication services through the Internet 428. Local network 422 and Internet 428 both use electrical, electromagnetic or optical signals which carry digital data streams. The signals through the various networks and the signals on network link 420 and through communication interface 418, which carry the digital data to and from computer 400 are exemplary forms of carrier waves transporting the information.

Computer 400 can send messages and receive data, including program code, through the network(s), network link 420 and communication interface 418. In the Internet example, a server 430 might transmit a requested code for an application program through Internet 428, ISP 426, local network 422 and communication interface 418. Consistent with the present invention, one such downloaded application is the software SMI handling process described herein.

The received code may be executed by CPU 404 as it is received, stored in storage device 410, or stored in some other non-volatile storage for later execution. In this manner, computer 400 may obtain application code in the form of a carrier wave.

While the invention has been described and illustrated as one in which a planar original is scanned, this is not critical. In fact, persons skilled in the art will readily understand how many of the techniques may be used for scanning three-dimensional images. However, the preferred embodiment is one in which the image of interest is formed on a medium, such as a piece of paper, a transparency, or a photograph, and the scanning device is in contact with the medium.

1-24. (canceled)

25. A calling program validation method comprising:
compiling program source code;
identifying at least one predetermined indication in the source code that identifies a location of an SMI call and its target;
creating a dispatch table based on information associated with the predetermined indication, wherein each entry in the dispatch table associates a caller, which generates an SMI in the program, with a target function to be executed in system management mode (SMM); and
storing the dispatch table where it is accessible by a dispatcher in SMM.

26. The method of claim 25, wherein the predetermined indication identifies to which target function to dispatch.

27. The method of claim 25, further comprising:
identifying callers in the dispatch table by address, and
sorting the entries in the dispatch table according to the addresses of the callers.

28. The method of claim 25, further comprising:
linking complied SMM code together with the dispatch table.

29. The method of claim 28, further comprising:
executing the program;
detecting the generation of an SMI from a caller in the program;
determining in SMM if the caller is included in the dispatch table;
dispatching to a target function that is associated with the caller in the dispatch table if it is determined that the caller is included in the dispatch table; and
executing the target function.

30. A calling program validation device comprising:
a compiler for compiling a program available in source code and identifying at least one predetermined indication in the source code that identifies the locations of an SMI call and its target;
a table unit for creating a dispatch table based on information associated with the predetermined indication, wherein each entry in the dispatch table associates a caller, which generates an SMI in the program, with a target function to be executed in system management mode (SMM); and
a linker for storing the dispatch table where it is accessible to a dispatcher in SMM.

31. The device of claim 30, wherein the predetermined indication identifies to which target function to dispatch.

32. The device of claim 30, further comprising:
an identification unit for identifying callers in the dispatch table by address; and
a sorting unit for sorting the entries in the dispatch table according to the addresses of the callers.

33. The device of claim 30, wherein the linker links the compiled SMM code together with the dispatch table.

34. The device of claim 33, further comprising:
a processing unit for executing the program;
a monitoring unit for detecting the generation of an SMI from a caller in the program and determining in SMM if the caller is included in the dispatch table; and
a transfer unit for dispatching to a target function that is associated with the caller in the dispatch table if it is determined that the caller is included in the dispatch table,
wherein the processing unit executed the target function.

35. A computer system comprising a device for developing a program system that can validate system management interrupt (SMI) calls generated by a program available in source code form, the device configured to:
compile the source code;
identify at least one predetermined indication in the source code that identifies the location of an SMI call and its target;
create a dispatch table based on information associated with the predetermined indication, wherein each entry in the dispatch table associates a caller, which generates an SMI in the program, with a target function to be executed in a system management mode (SMM); and
store the dispatch table where it is accessible to a dispatcher in SMM.

36. The method of claim 35, wherein the predetermined indication identifies to which target function to dispatch.

37. The method of claim 35, wherein the device is further configured to:
identify callers in the dispatch table by addresses; and
sort the entries in the dispatch table according to addresses of the callers.

38. The method of claim 35, wherein the device is further configured to:
link compiled SMM code together with the dispatch table.

39. The method of claim 38, wherein the device is further configured to:
execute the program;
detect the generation of an SMI form a caller in the program;
determine in SMM if the caller is included in the dispatch table;
dispatch to a target function that is associated with the caller in the dispatch table if it is determined that the caller is included in the dispatch table; and
execute the target function.

40. A computer readable storage device having a utility for developing a program system that can validate system management interrupt (SMI) calls generated by a program available in source code form, the utility comprising:
a compiler for compiling the source code and identifying at least one predetermined indication in the source code that identifies the location of an SMI call and its target;
a table unit for creating a dispatch table based on information associated with the predetermined indication, wherein each entry in the dispatch table associates a caller, which generates an SMI in the program, with a target function to be executed in a system management mode (SMM); and
a linker for storing the dispatch table where it is accessible to a dispatcher in SMM.

41. The utility of claim 40, wherein the predetermined indication identifies to which target function to dispatch.

42. The utility of claim 40, further comprising:
an identification unit for identifying callers in the dispatch table by addresses; and
a sorting unit for sorting the entries in the dispatch table according to addresses of the callers.

43. The utility of claim 40, wherein the linker links compiled SMM code together with the dispatch table.

44. The utility of claim 43, further comprising:
a processing unit for executing the program;
a monitoring unit for detecting the generation of an SMI from a caller in the program and determining in SMM if the caller is included in the dispatch table; and
a transfer unit for dispatching to a target function that is associated with the caller in the dispatch table if it is determined that the caller is included in the dispatch table,
wherein the processing unit executed the target function.
